(19) United States
(12) Patent Application Publication
(10) Pub. No.: US 2011/0162339 A1
(43) Pub. Date: Jul. 7, 2011

(54) FLOW DISTRIBUTION OF GAS TURBINE EXHAUST USING WALLS SHAPED TO FACILITATE IMPROVED GAS FLOW

(75) Inventors: AARON ALEXANDER, Oologah, OK (US); LAQUINNIA LAWSON, JR., Tulsa, OK (US); RICHARD KING, Mobile, AL (US)

(73) Assignee: BRADEN MANUFACTURING, LLC, Tulsa, OK (US)

(21) Appl. No.: 12/986,657

(22) Filed: Jan. 7, 2011

(51) Int. Cl. F02C 7/00; F15D 1/02

(52) U.S. Cl. 60/39.5; 137/833

(57) ABSTRACT

A gas turbine transition into an emission reduction catalyst is improved by adding properly curved surfaces so as to induce the Coanda effect. Such a surface allows for a reduction in pressure drop, shorter duct lengths, and elimination of some or all of traditionally used flow re-distribution devices.

### FIELD OF THE INVENTION

This invention relates to the distribution of gas as it transitions through a turbine exhaust duct from a gas turbine exhaust to a larger area necessary to accommodate emissions catalysts. More particularly, the invention relates to a transition section in the turbine exhaust duct for improving distribution of the turbine exhaust gas.

### BACKGROUND OF THE INVENTION

Catalytic reduction systems are used to remove pollutants such as carbon monoxide (CO) and nitrogen oxides (NOx) from combustion products of gas turbines used in power generation. The catalysts used in such catalytic reduction systems are designed to be used within a specific range of air flow velocities. The catalyst is typically presented in a large vertical porous structure located in an exhaust duct or conduit. The porous structure allows exhaust gases to pass through in proximity to catalyst elements. Other designs of catalyst trays may also be used. To accommodate the catalyst, a significant expansion of duct cross-sectional area is required as compared to the cross sectional area of the turbine exhaust. Symmetric or asymmetric transition ducts may be required to accommodate the large catalysts, depending on available space, equipment orientation, and other factors associated with a gas turbine unit.

A conventional prior art gas turbine and gas turbine exhaust duct, as shown in FIGS. 1 and 2, uses a straight wall transition duct with flow redistribution devices, such as perforated plates, that redistribute gas turbine exhaust gas flow by creating local obstructions or areas of higher pressure drop. This method can be expensive as it requires long duct lengths and high system pressure drops to achieve the needed redistribution.

Example prior art gas turbine unit 10 is disclosed in greater detail as follows.

Referring now to FIGS. 1-3, shown is a prior art gas turbine unit designated generally 10 (FIG. 1). Example gas turbine unit 10 is a simple cycle SCR unit. However, the invention described herein may be used with other types of gas turbine units, including emission reduction systems, units with heat recovery steam generation systems or other types of gas turbine units. Gas turbine unit 10 includes inlet air filtration system 12 which feeds air to gas turbine 14. Gas turbine exhaust exits from gas turbine 14 through gas turbine exhaust outlet 16. Gas turbine exhaust flows into inlet 18 of gas turbine exhaust duct 20 (FIGS. 1 and 2), whereupon gas turbine exhaust is directed to exhaust stack 22.

As shown in FIG. 2, gas turbine exhaust gas 24 can be seen entering inlet 18 of gas turbine exhaust duct 20. In exemplary gas turbine exhaust duct 20 of FIGS. 1 and 2, gas turbine exhaust duct 20 supports and encloses vertical CO catalyst 26 (FIGS. 2, 3), vertical ammonia injection grid 28 (FIG. 2) and vertical SCR (selective catalytic reduction) catalyst 30 (FIG. 2). Gas turbine exhaust duct 20 is made up of a transition section 32 (FIGS. 1-3) which transitions from a relatively small inlet 18 to a relatively larger area, i.e., expanded area 33 (FIGS. 1, 2) that accommodates catalysts 26 and/or 28 and/or 30 or other suitable catalysts.

Referring now primarily to FIG. 3, shown is an enlarged isometric view of prior art transition section 32. Transition section 32 is made up of top wall 34, bottom wall 36, first side wall 38, and second side wall 40. It can be seen that walls 34-40 converge to form inlet 18 on a first end and expand outwardly to define an outlet end 42. Perforated plate redistributive device for housing catalyst 26 is visible within transition section 32.

In the prior art design of FIG. 3, turbine exhaust gas must be forced by some means into the expanded area. This often requires large pressure drops and long duct lengths as the gas flow tends to form eddies and does not naturally follow the angle of the duct walls.

### SUMMARY OF THE INVENTION

The present invention relates to an exhaust duct designed to better distribute flow of exhaust gas from a gas turbine. The turbine exhaust gas expands within the exhaust duct to flow through an emissions reduction catalyst.

A curved surface inserted into a flow stream tends to induce a flow of gas to follow the surface. This phenomenon is often referred to as the Coanda effect. The current invention introduces at least one curved exhaust duct wall in a transition section between a turbine and a catalyst, thereby allowing a reduction in either or both duct length and/or redistributive devices as well as an immediate reduction of pressure drop.

By providing a curved surface for at least one duct wall that is shaped to optimally draw the gas from a high speed exhaust stream into an expanded area of a duct, an improved distribution effect may be achieved. The use of curved surfaces on other duct walls may also be used to achieve a desired distribution effect.

### BRIEF DESCRIPTION OF THE DRAWINGS

FIG. 1 is an isometric view of a prior art simple cycle SCR gas turbine unit of the type that may be fitted with the duct transition section of the invention;

FIG. 2 is an enlarged elevation view of a prior art turbine exhaust duct of FIG. 1 having a transition section;

FIG. 3 is an enlarged isometric view of a prior art exhaust conduit transition section of FIGS. 1 and 2 having perforated plates and straight angled walls;

FIG. 4 is an isometric view of a curved wall transition section of the invention depicting one wall, i.e., a top wall, of the transition section curved to induce a Coanda effect;

FIG. 5 is a plan view of another embodiment of a curved wall transition section depicting curved sidewalls of a transition section of an exhaust conduit to induce a Coanda effect;

FIG. 6 is a plan view of another embodiment of a curved wall transition section depicting one curved sidewall of a transition section of an exhaust conduit to induce a Coanda effect;

FIG. 7 is an elevation view of another embodiment of a curved wall transition section depicting an additional embodiment of a curved upper wall of a transition section of an exhaust conduit to induce a Coanda effect;

FIG. 8 is an elevation view of another embodiment of a curved walled transition section depicting curved upper and lower walls of a transition section of an exhaust conduit to induce a Coanda effect;

FIG. 9 is an elevation view of another embodiment of a curved wall transition section depicting an additional embodiment of a curved upper wall of a transition section of an exhaust conduit that curves into the gas flow before curving away to induce a Coanda effect.

### DETAILED DESCRIPTION OF THE PREFERRED EMBODIMENTS

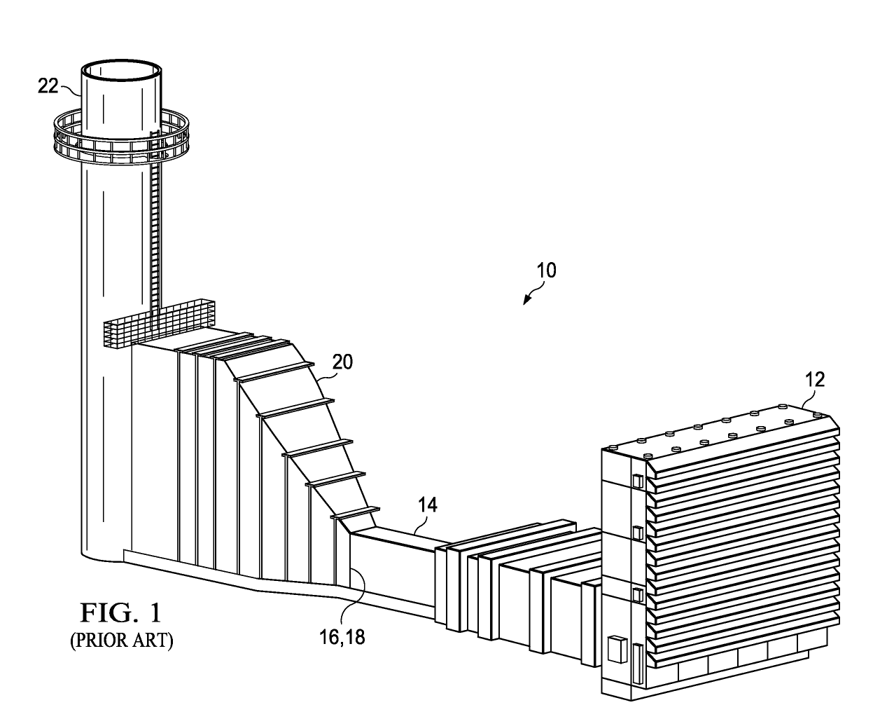

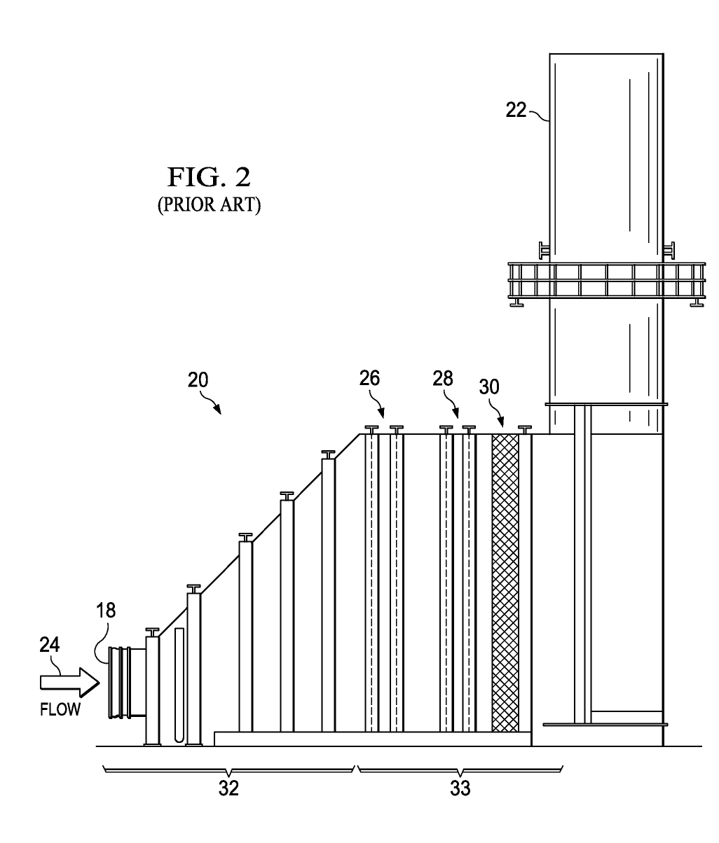

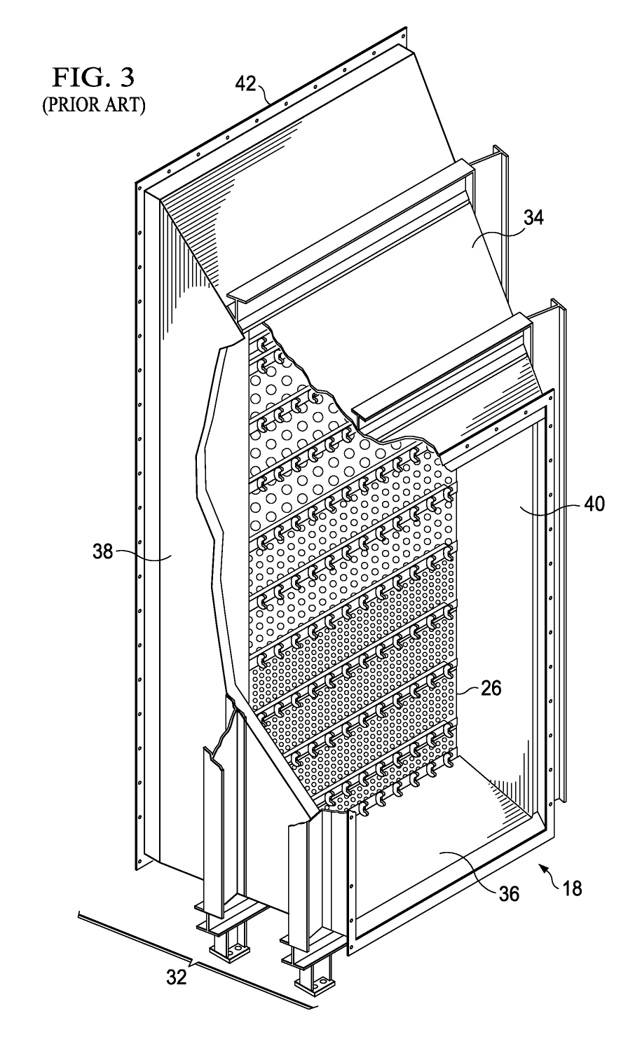

The invention relates to an inventive transition section of a gas turbine exhaust duct that better distributes flow of exhaust gas from a gas turbine. The transition section embodiments discussed below may be used to replace prior art transition section 32 of FIGS. 1-3, or may be used as transition sections in other gas turbine units to achieve improved gas distribution.

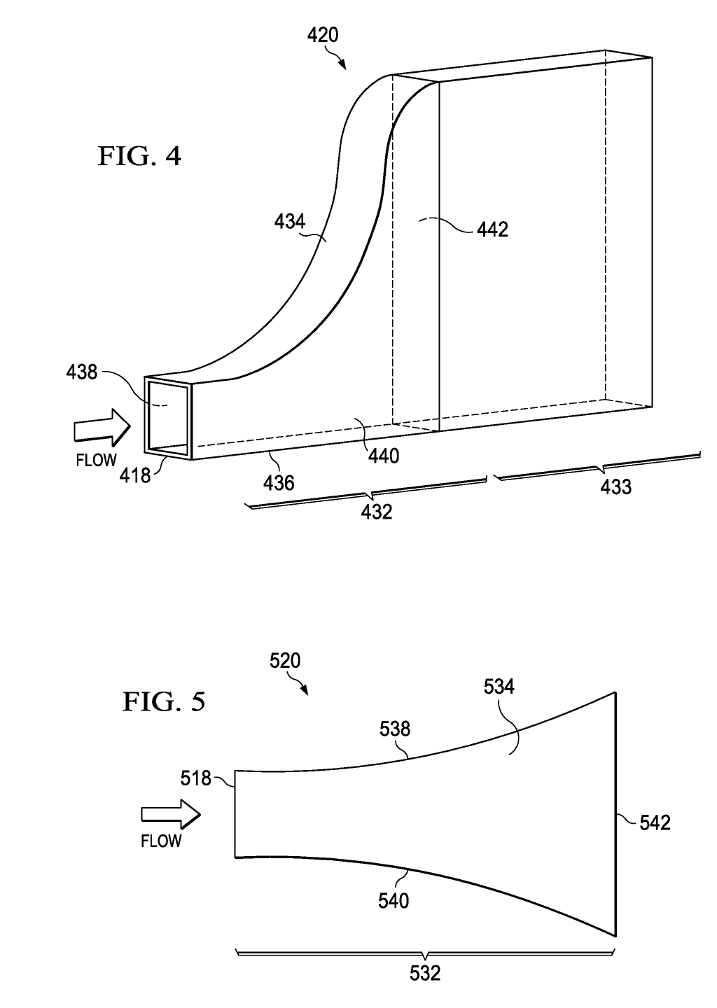

Referring now to FIG. 4, duct transition section 432 of the invention includes a gas turbine transition duct 420 having an upper curved wall 434. Upper curved wall 434 is curved in a non-linear manner to follow a path that assists in expanding turbine exhaust gas into larger duct area 433. Gas turbine exhaust duct 420 has inlet 418, and transition section 432. Transition section 432 has curved top wall 434, bottom wall 436, first side wall 438, and second side wall 440. Transitional section 432 additionally has an outlet end 442. In one embodiment, upper curved wall 434 increases in slope over a first distance, then levels off to interface with expanded area 433. In one embodiment, the curve followed by top wall 434 may be described by a third degree polynomial equation.

Referring now to FIG. 5, shown is another embodiment of a gas turbine transition section 532 of a gas turbine exhaust duct. Gas turbine transition section 532 has an inlet 518 and an outlet 542. In this embodiment, transition section 532 expands laterally to accommodate a duct having a width greater than the width of inlet 518 (not shown). Therefore, top wall 534 and bottom wall 536 may be straight and flat, while first side wall 538 and second side wall 540 curve outwardly. In one embodiment, the curves followed by side walls 538, 540 increase in slope with regard to a center line of transition section 532 over a length of transition section 532. In one embodiment, the curve followed by side walls 538 and 540 may be described by a second degree polynomial equation.

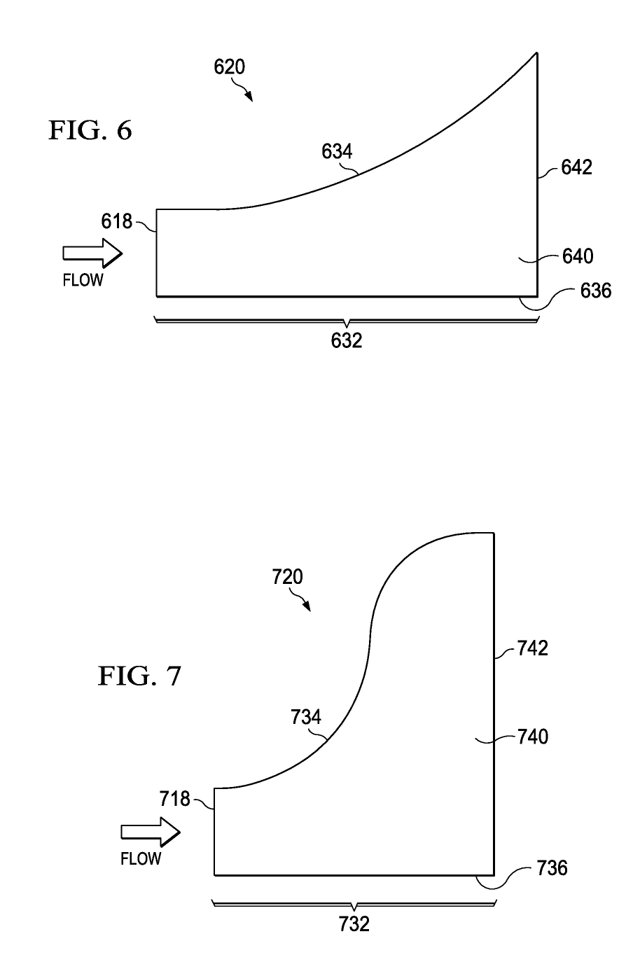

Referring now to FIG. 6, shown is another embodiment of a transition section 632 of a gas turbine exhaust duct 620. Gas turbine transition section 632 has inlet 618, a curved top wall 634, a bottom wall 636, a first side wall (not shown), and a second side wall 640. Transitional section 632 additionally has an outlet end 642. In one embodiment, the curve followed by top wall 634 increases in slope over a length of transition section 632. In one embodiment, the curve followed by top wall 634 may be described by a second degree polynomial equation.

Referring now to FIG. 7, shown is transition section 732 of a gas turbine exhaust duct 720. Gas turbine transition section 732 has inlet 718, curved top wall 734, bottom wall 736, first side wall (not shown), and second side wall 740. Transition section 732 additionally has an outlet end 742. In one embodiment, the curve followed by top wall 734 increases in slope over a length of transition section 732. In one embodiment, the curve followed by top wall 734 may be described by a third degree polynomial equation.

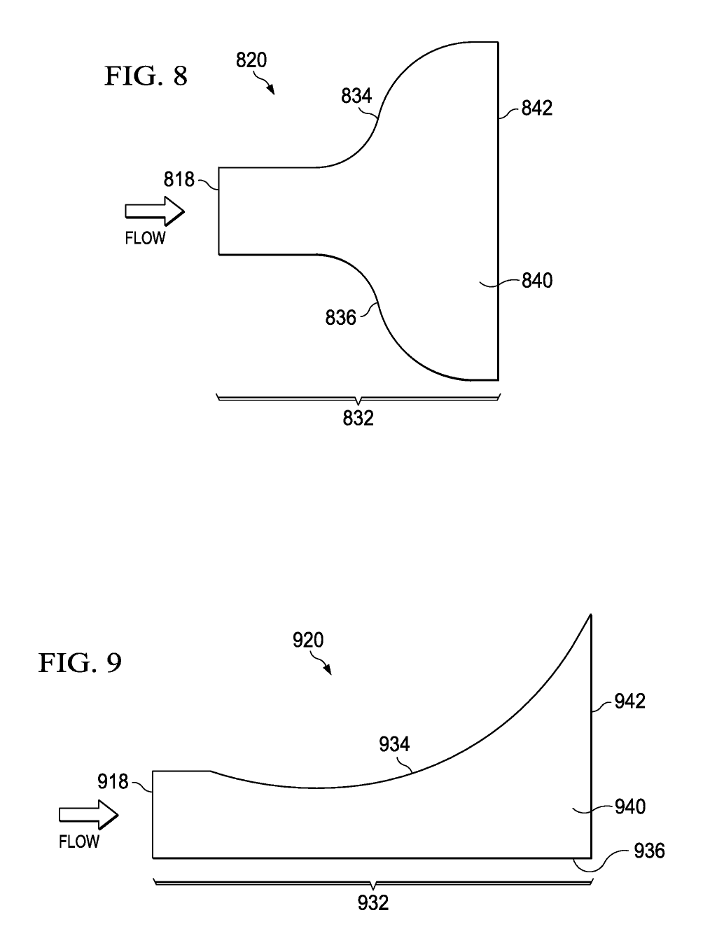

Referring now to FIG. 8, shown is an elevational view of transitional section 832 of gas turbine exhaust duct 820. Transition section 832 has an inlet 818, curved top wall 834 and curved bottom wall 836. First side wall (not shown) and second side wall 840 may be straight. Transitional section 832 additionally has an outlet end 842. In one embodiment, the curve followed by curved walls 834 and 836 has a slope that increases in magnitude with regard to a centerline of transitional section 832 over a first distance, then levels off to an interface with an expanded area (not shown). In one embodiment, curves followed by walls 834 and 836 may be described by a third degree polynomial equation.

Referring now to FIG. 9, shown is gas turbine transition section 932 of a turbine exhaust duct 920. Gas turbine transition section 932 has inlet 918, a curved top wall 934, a bottom wall 936, a first side wall (not shown), and a second side wall 940. Transition section 932 additionally has an outlet end 942. In one embodiment, curved top wall 934 has a straight portion adjacent to inlet 918, a portion where top wall 934 follows a curve with decreasing slope over a length of transition section 932, which results in a narrowing of transition section 932, then a portion of increasing slope. In one embodiment, the curve followed by top wall 934 may be described by a second degree polynomial equation.

Turbine transition ducts 432, 532, 632, 732, 832, and 932 may be used with gas turbine exhaust ducts of simple cycle units, units with emission reductions systems, or units with heat recovery steam generation systems or other turbine units. The curved transition ducts 432, 532, 632, 732, 832, and 932 are equally appropriate for expansion or contraction of gas streams.

In the present invention, duct walls nearest the turbine exhaust preferably begin with a straight surface parallel to the turbine exhaust gas stream flowing along it. In some applications, this wall may actually be slightly curved toward the exhaust stream (see, e.g., upper wall 934 in FIG. 9) to capture a greater percentage of the gas flow. In a preferred embodiment, after capturing the gas flow with the straight or convex surface, the subsequent duct surface of a duct wall, e.g., walls 434, 538, 540, 634, 734, 834, 836, begins to curve away from the flow stream with an angle that begins small and that increases in magnitude for a length as the wall progresses. The turbine exhaust gas that was in contact with the straight duct wall continues to follow the curved wall as the gas turns away from the rest of the flow stream. Walls that follow a well designed curve will immediately reduce the pressure drop of the system while allowing for a shorter transition duct.

What is claimed is:

1. An exhaust duct for a gas turbine comprising:
a transition section having a top wall, a first side wall, a second side wall, and a bottom wall, said transition section having an intake for receiving turbine exhaust gas and a relatively larger outlet area;
wherein at least one of said top wall, said first side wall, said second side wall and said bottom wall define a curved surface; and
wherein said curved surface is between said intake and said outlet area.

2. The exhaust duct according to claim 1 wherein:
said outlet area is sized to accommodate a catalyst having one of a height and width greater than a corresponding height and width of said intake.

3. The exhaust duct according to claim 1 wherein:
said curved surface may be described by a second degree polynomial equation, thereby continuously expanding an area of said transition section as a distance from said intake is increased.

4. The exhaust duct according to claim 1 wherein:
said curved surface may be described by a third degree polynomial equation.

5. The exhaust duct according to claim 1 wherein:
said curved surface increases in slope as a function of distance from said intake.

6. The exhaust duct according to claim 1 wherein:
said curved surface has a section that increases in slope and a second section that decreases in slope as a function of distance from said intake.

7. The exhaust duct according to claim 1 wherein:
said curved surface has a section with a negative slope and has a section with a positive slope.

8. A gas turbine unit comprising:
a gas turbine having an outlet for gas turbine exhaust;
an exhaust duct having an intake for receiving said gas turbine exhaust, said exhaust duct having a transition section and an expanded area;
said transition section having a top wall, a first side wall, a second side wall, and a bottom wall, and an outlet area having a larger cross-section area than a cross-sectional area of said inlet;
wherein said outlet area is adjacent to said expanded area;
wherein at least one of said top wall, said first side wall, said second side wall and said bottom wall of said transition section define a curved surface; and
wherein said curved surface is between said intake and said outlet area.

9. The gas turbine unit according to claim 8 wherein:
said outlet area is sized to accommodate a catalyst having one of a height and width greater than a corresponding height and width of said intake.

10. The gas turbine unit according to claim 8 wherein:
said curved surface may be described by a second degree polynomial equation, thereby continuously expanding an area of said transition section as a distance from said intake is increased.

11. The gas turbine unit according to claim 8 wherein:
said curved surface may be described by a third degree polynomial equation.

12. The gas turbine unit according to claim 8 wherein:
said curved surface increases in slope as a function of distance from said intake.

13. The gas turbine unit according to claim 8 wherein:
said curved surface has a section that increases in slope and a second section that decreases in slope as a function of distance from said intake.

14. The gas turbine unit according to claim 8 wherein:
said curved surface has a section with a negative slope and has a section with a positive slope.
